(19) United States
(12) Patent Application Publication
(10) Pub. No.: US 2026/0257131 A1
(43) Pub. Date: Sep. 3, 2026

(54) PHOTO CAPTIONING GAME

(71) Applicant: Donna Masterman, Del Mar, CA (US)

(72) Inventor: Donna Masterman, Del Mar, CA (US)

(21) Appl. No.: 19/068,208

(22) Filed: Mar. 3, 2025

(51) Int. Cl. A63F 13/24; A63F 13/46

(52) U.S. Cl. CPC A63F 13/24; A63F 13/46; A63F 2300/405

(57) ABSTRACT

A photo captioning game includes a base housing and a base display coupled to the base housing display imagery. A plurality of personal electronic devices is provided and each personal electronic device stores a database comprising a photo captioning application. Each personal electronic device is in wireless communication with the base display. The photo captioning application stored in each personal electronic device generates a caption which pertains to a digital image which is displayed on the base display. Each of the personal electronic devices broadcasts a vote to the base display which pertains to the caption displayed on the base display. Each vote is counted to determine which caption receives the most votes from the players such that the player whose caption receives the most votes is awarded one point.

### (B) CROSS-REFERENCE TO RELATED APPLICATIONS

Not Applicable

### (C) STATEMENT REGARDING FEDERALLY SPONSORED RESEARCH OR DEVELOPMENT

Not Applicable

### (D) THE NAMES OF THE PARTIES TO A JOINT RESEARCH AGREEMENT

Not Applicable

### (E) INCORPORATION-BY-REFERENCE OF MATERIAL SUBMITTED ON A

### COMPACT DISC OR AS A TEXT FILE VIA THE OFFICE ELECTRONIC FILING SYSTEM

Not Applicable

### (F) STATEMENT REGARDING PRIOR DISCLOSURES BY THE INVENTOR OR JOINT INVENTOR

Not Applicable

### (G) BACKGROUND OF THE INVENTION

### (1) Field of the Invention

The disclosure relates to captioning games and more particularly pertains to a new captioning game for creating custom captions for digital pictures and subsequently voting on the best caption. The game includes a base housing and a base display integrated into the base housing which display digital imagery. The game includes a plurality of personal electronic devices which are each in wireless communication with the base display and each personal electronic device stores a captioning application. Each of the personal electronic devices is assigned to a respective player. A digital image is viewed on the base display and each player designs a caption for the digital image with the captioning application which is subsequently displayed on the base display. Each player votes for what they feel is the best caption and the player who gets the most votes wins a point.

### (2) Description of Related Art Including Information Disclosed Under 37 CFR 1.97 and 1.98.

The prior art relates to captioning games including: a variety of board games which each at least includes a gaming board and game pieces which are moved along the game board; an electronic board game which includes a gaming board and a plurality of player displays each disposed on the gaming board for displaying imagery and a common display which is centrally positioned on the gaming board. In no instance does the prior art disclose a photo captioning game that includes a base display and a plurality of personal electronic devices which are each in wireless communication with the base display which are each assigned to a player that creates a caption for an image displayed on the base display for each of the players to subsequently vote for the best caption.

### (H) BRIEF SUMMARY OF THE INVENTION

An embodiment of the disclosure meets the needs presented above by generally comprising a base housing and a base display coupled to the base housing display imagery. A plurality of personal electronic devices is provided and each personal electronic device stores a database comprising a photo captioning application. Each personal electronic device is in wireless communication with the base display. The photo captioning application stored in each personal electronic device generates a caption which pertains to a digital image which is displayed on the base display. Each of the personal electronic devices broadcasts a vote to the base display which pertains to the caption displayed on the base display. Each vote is counted to determine which caption receives the most votes from the players such that the player whose caption receives the most votes is awarded one point.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (I) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a photo captioning game according to an embodiment of the disclosure.

FIG. 2 is a front perspective view of a base housing of an embodiment of the disclosure.

FIG. 3 is a schematic view of an embodiment of the disclosure.

FIG. 4 is a perspective in-use view of an embodiment of the disclosure.

### (J) DETAILED DESCRIPTION OF THE INVENTION

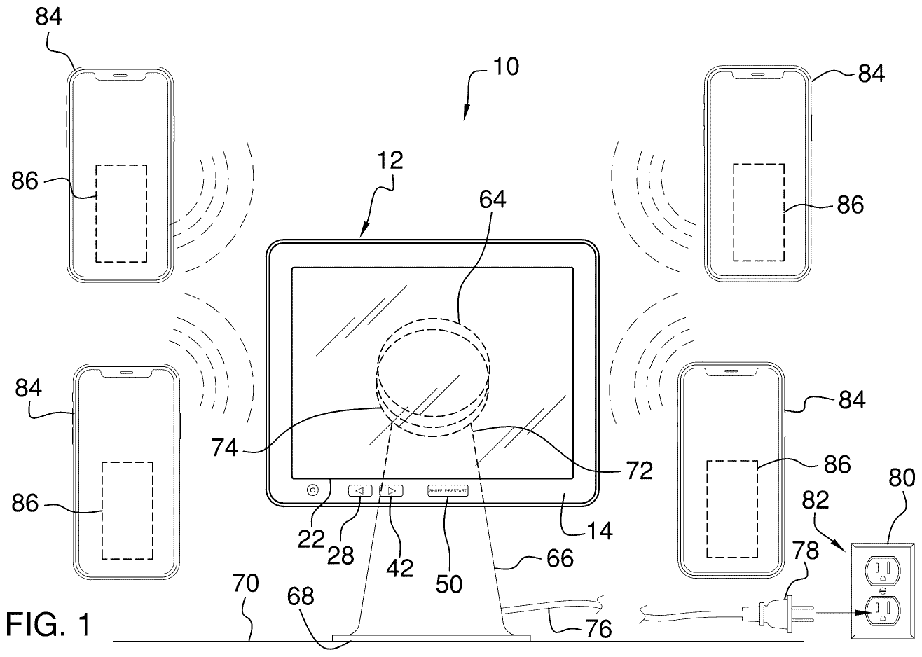

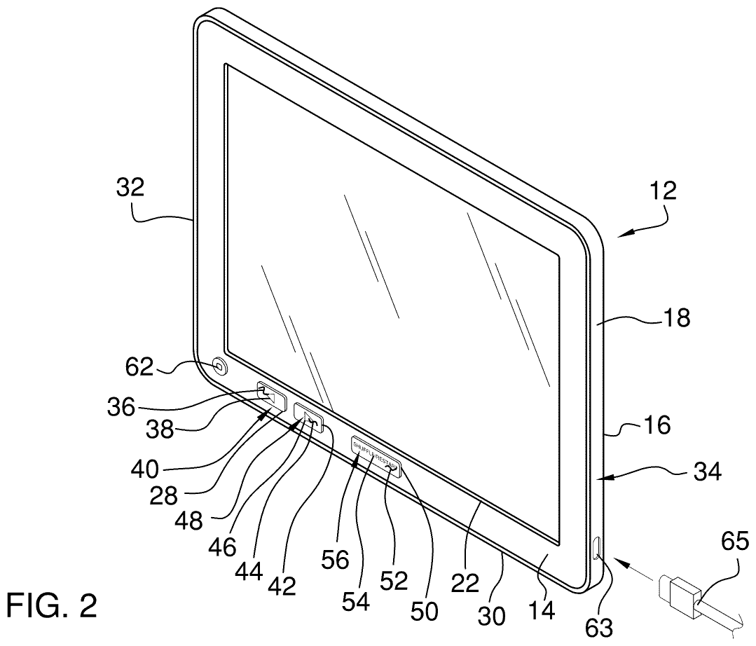

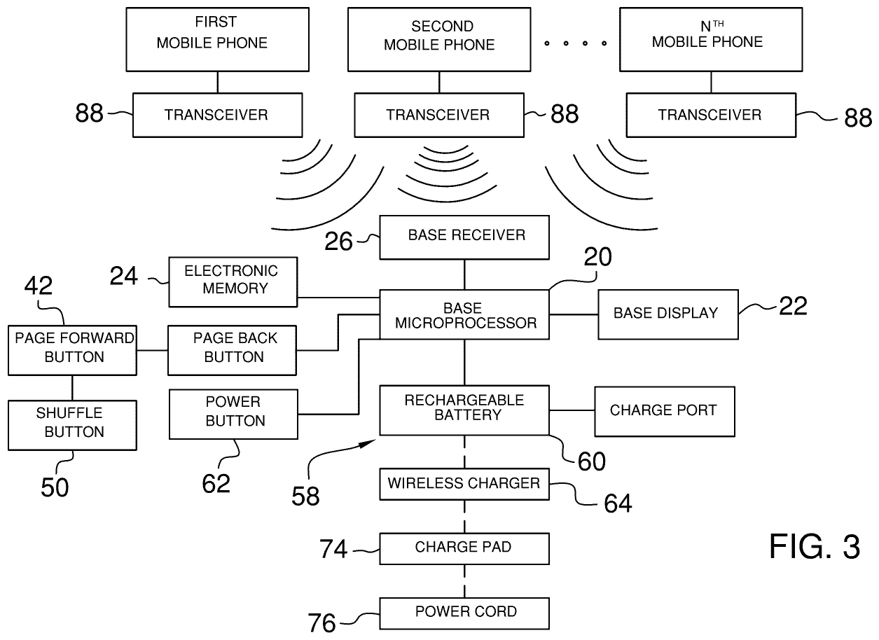

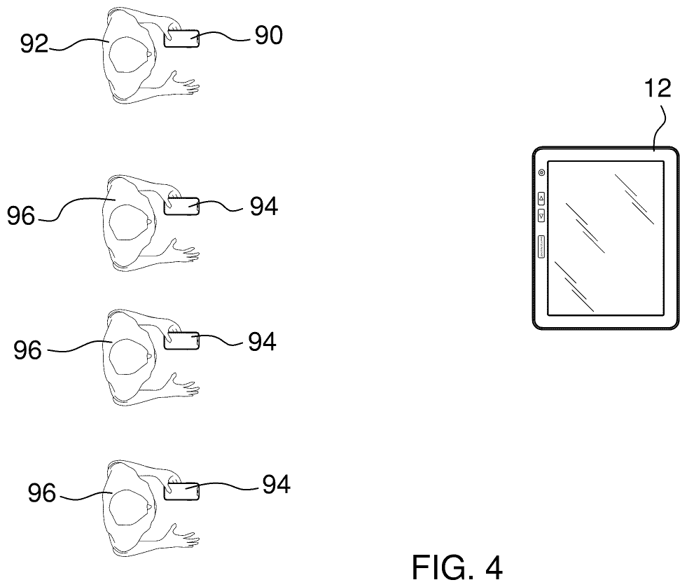

With reference now to the drawings, and in particular to FIGS. 1 through 4 thereof, a new captioning game embodying the principles and concepts of an embodiment of the disclosure and generally designated by the reference numeral 10 will be described.

As best illustrated in FIGS. 1 through 4, the photo captioning game 10 generally comprises a base housing 12 that has a front wall 14 and a back wall 16 and an outer wall 18 extending between the front wall 14 and the back wall 16. A base processor 20 is integrated into the base housing 12 and a base display 22 is coupled to the front wall 14 of the base housing 12 which displays imagery. The base display 22 is in electrical communication with the base processor 20 and the base display 22 may comprise a light emitting diode base display or other type of electronic base display. A base electronic memory 24 is integrated into the base housing 12 and the base electronic memory 24 is in electrical communication with the base processor 20. The base electronic memory 24 stores a database comprising a plurality of digital images and a vote counting application.

A base transceiver 26 is integrated into the base housing 12 and the base transceiver 26 is in electrical communication with the base processor 20. The base transceiver 26 may comprise a radio frequency transceiver or the like and the base transceiver 26 may employ Bluetooth communication protocols. A page back button 28 is movably integrated into the front wall 14 of the base housing 12. The outer wall 18 of the base housing 12 has a bottom side 30 and a first lateral side 32 and a second lateral side 34. The page back button 28 is positioned between the base display 22 and the bottom side 30 of the outer wall 18 of the base housing 12. Additionally, the page back button 28 is positioned closer to the first lateral side 32 of the outer wall 18 than the second lateral side 34 of the outer wall 18.

The page back button 28 is in electrical communication with the base processor 20 and the base display 22 is actuated to cycle back through the plurality of digital images stored in the database in the base electronic memory 24 when the page back button 28 is depressed. The page back button 28 has an exposed surface 36 with respect to the front wall 14 of the base housing 12. The page back button 28 has back arrow indicia 38 which are applied to the exposed surface 36. The back arrow indicia 38 comprise an image of an arrow 40 pointing toward the first lateral side 32 of the outer wall 18 of the base housing 12.

A page forward button 42 is movably integrated into the front wall 14 of the base housing 12. The page forward button 42 is positioned between the base display 22 and the bottom side 30 of the outer wall 18 of the base housing 12 and the page forward button 42 is positioned between the page back button 28 and the second lateral side 34 of the outer wall 18 of the base housing 12. The page forward button 42 is in electrical communication with the base processor 20. The base display 22 is actuated to cycle forward through the plurality of digital images stored in the database in the base electronic memory 24 when the page forward button 42 is depressed. The page forward button 42 has an exposed surface 44 of the page forward button 42 with respect to the front wall 14 of the base housing 12. The page forward button 42 has forward arrow indicia 46 which are applied to the exposed surface 44 of the page forward button 42. Furthermore, the forward arrow indicia 46 comprise an image of an arrow 48 pointing toward the second lateral side 34 of the outer wall 18 of the base housing 12.

A shuffle button 50 is movably integrated into the front wall 14 of the base housing 12. The shuffle button 50 is positioned between the base display 22 and the bottom side 30 of the outer wall 18 of the base housing 12 and the shuffle button 50 is positioned closer to the page forward button 42 than the second lateral side 34 of the outer wall 18 of the base housing 12. The shuffle button 50 is in electrical communication with the base processor 20. Additionally, the base display 22 is actuated to display a randomly selected one of the plurality of digital images stored in the database in the base electronic memory 24 when the shuffle button 50 is depressed. The shuffle button 50 has an exposed surface 52 of the shuffle button 50 and the shuffle button 50 has shuffle indicia 54 applied to the exposed surface 52 of the shuffle button 50. Furthermore, the shuffle indicia 54 comprise the words “shuffle/restart” 56.

A base power supply 58 is integrated into the base housing 12 and the base power supply 58 is in electrical communication with the base processor 20. The base power supply 58 comprises a rechargeable battery 60 which is integrated into the base housing 12 and the rechargeable battery 60 is in electrical communication with the base processor 20. The base power supply 58 includes a power button 62 which is movably integrated into the front wall 14 of the base housing 12. The power button 62 is positioned between the base display 22 and the bottom side 30 of the outer wall 18 of the base housing 12 and the power button 62 is positioned between the page back button 28 and the first lateral side 32 of the outer wall 18 of the base housing 12. The power button 62 is in electrical communication with the base processor 20; the base processor 20 is actuated when the power button 62 is depressed an initial time and the base processor 20 is de-actuated when the power button 62 is depressed a subsequent time. The base power supply 58 includes a wireless charger 64 which is integrated into the back wall 16 of the base housing 12 and the wireless charger 64 is in electrical communication with the rechargeable battery 60. The wireless charger 64 is comprised of a ferromagnetic material, including but not being limited to steel or iron. The base power supply 58 includes a charge port 63 recessed into the outer wall 18 of the base housing 12 and the charge port 63 is in electrical communication with the rechargeable battery 60. The charge port 63 insertably receives a charge cord 65 to charge the rechargeable battery 60.

A charging stand 66 is provided which has a bottom end 68 that can be positioned on a support surface 70. The support surface 70 may be a table top, for example, or other type of horizontal support surface. The charging stand 66 has a top end 72 which is elevated over the support surface 70 and the charging stand 66 has a charge pad 74 which is coupled to the top end 72. The charge pad 74 lies on a plane which is oriented perpendicular to an axis extending between the top end 72 and the bottom end 68 of the charging stand 66. Additionally, the charge pad 74 is comprised of a magnetic material and the charge pad 74 magnetically engages the wireless charger 64 when the back wall 16 of the base housing 12 is positioned against the charge pad 74. The charge pad 74 broadcasts a charging signal to the wireless charger 64 when the charge pad 74 magnetically engages the wireless charger 64 for charging the rechargeable battery 60. The charging stand 66 includes a power cord 76 which is in electrical communication with the charge pad 74. The power cord 76 has a male plug 78 which can be electrically mated to a power source 80 comprising a female electrical outlet 82.

A plurality of personal electronic devices 84 is provided and each personal electronic device 84 of the plurality of personal electronic devices 84 includes a personal electronic memory 86. The personal electronic memory 86 associated with each personal electronic device 84 of the plurality of personal electronic devices 84 stores a database comprising a photo captioning application. Additionally, each personal electronic device 84 of the plurality of personal electronic devices 84 includes a personal transceiver 88. The personal transceiver 88 associated with each personal electronic device 84 of the plurality of personal electronic devices 84 is in wireless communication with the base transceiver 26. The personal transceiver 88 associated with each personal electronic device 84 may comprise a radio frequency transceiver or the like and the personal transceiver 88 associated with each personal electronic device 84 may employ Bluetooth communication protocols. Furthermore, each personal electronic device 84 of the plurality of personal electronic devices 84 may comprise a smart phone or other similar type of electronic device.

The plurality of personal electronic devices 84 includes a lead electronic device 90 which is assigned to a lead player 92. The plurality of personal electronic devices 84 includes a set of player electronic devices 94 which is each assigned to a respective one of a plurality of players 96. The photo captioning application stored in the personal electronic memory 86 associated with each player electronic device of the set of player electronic devices 94 generates a caption which pertains to the digital image which is displayed on the base display 22. Furthermore, the personal transceiver 88 in each player electronic device 94 of the set of player electronic devices 94 broadcasts the caption generated by the photo captioning application stored in the personal electronic memory 86 associated with each player electronic device 94 of the set of player electronic devices 94 to the base transceiver 26. The plurality of digital images stored in the base electronic memory 24 may comprise stock images downloaded from the internet or the plurality of digital images may comprise digital images that are downloaded from each personal electronic device.

The base display 22 displays the caption generated by the photo captioning application stored in the personal electronic memory 86 associated with each player electronic device 94 of the set of player electronic devices 94. Furthermore, the personal transceiver 88 in each player electronic device 94 of the set of player electronic devices 94 broadcasts a vote to the base transceiver 26 which pertains to the caption displayed on the base display 22. The personal transceiver 88 in each player electronic device 94 of the set of player electronic devices 94 enables each player 96 of the plurality of players 96 to vote for their favorite caption. The vote counting application stored in the base electronic memory 24 counts each vote which is broadcast to the base transceiver 26 to determine which caption receives the most votes from the players 96 such that the player 96 whose caption receives the most votes is awarded one point.

In use, the plurality of digital images are downloaded into the base electronic memory 24 and the lead player 92 employs either the page forward button 42 or the page back button 28 to display a digital image of the lead player's 92 choice on the base display 22 or the lead player 92 employs the shuffle button 50 to randomly display one of the digital images on the base display 22. Each of the players 96 views the digital image that is displayed on the base display 22 and each player 96 employs the photo captioning application that is stored in the personal electronic device 84 that is assigned to them to create their own custom caption which is subsequently downloaded into the base electronic memory 24. The base display 22 displays each of the captions and each player 96 employs the photo captioning application to cast their vote for the caption they feel is the best caption. The vote counting application stored in the base electronic memory 24 counts the votes and the player 96 who created the caption that gets the most votes is awarded one point. The process of displaying a digital image on the base display 22 and creating a custom caption and voting for the best caption is repeated as many times as the lead player 92 chooses. The player 96 who gains the most points at the end of the game wins the game.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A photo captioning game comprising:
a base housing;
a base processor being integrated into said base housing;
a base display being coupled to said base housing wherein said base display is configured to display imagery, said base display being in electrical communication with said base processor;
a base electronic memory being integrated into said base housing, said base electronic memory being in electrical communication with said base processor, said base electronic memory storing a database comprising a plurality of digital images and a vote counting application;
a base transceiver being integrated into said base housing, said base transceiver being in electrical communication with said base processor;
a page back button being movably integrated into said base housing, said page back button being in electrical communication with said base processor, said base display being actuated to cycle back through said plurality of digital images stored in said database in said base electronic memory when said page back button is depressed;
a page forward button being movably integrated into said base housing, said page forward button being in electrical communication with said base processor, said base display being actuated to cycle forward through said plurality of digital images stored in said database in said base electronic memory when said page forward button is depressed;
a shuffle button being movably integrated into said base housing, said shuffle button being in electrical communication with said base processor, said base display being actuated to display a randomly selected one of said plurality of digital images stored in said database in said base electronic memory when said shuffle button is depressed; and
a plurality of personal electronic devices, each personal electronic device of said plurality of personal electronic devices including a personal electronic memory, said personal electronic memory associated with each personal electronic device of said plurality of personal electronic devices storing a database comprising a photo captioning application, each personal electronic device of said plurality of personal electronic devices including a personal transceiver, said personal transceiver associated with each personal electronic device of said plurality of personal electronic devices being in wireless communication with said base transceiver, said plurality of personal electronic devices including a lead electronic device wherein said lead electronic device is configured to be assigned to a lead player, said plurality of personal electronic devices including a set of player electronic devices wherein each player electronic device of said set of player electronic devices is configured to be assigned to a respective one of a plurality of players, said photo captioning application stored in said personal electronic memory associated with each player electronic device of said set of player electronic devices generating a caption which pertains to said digital image which is displayed on said base display, said personal transceiver in each player electronic device of said set of player electronic devices broadcasting said caption generated by said photo captioning application stored in said personal electronic memory associated with each player electronic device of said set of player electronic devices to said base transceiver, said base display displaying said caption generated by said photo captioning application stored in said personal electronic memory associated with each player electronic device of said set of player electronic devices, said personal transceiver in each player electronic device of said set of player electronic devices broadcasting a vote to said base transceiver which pertains to said caption displayed on said base display wherein said personal transceiver in each player electronic device of said set of player electronic devices is configured to have each player of the plurality of players vote for their favorite caption, said vote counting application stored in said base electronic memory counting each vote which is broadcast to said base transceiver wherein said vote counting application is configured to determine which caption receives the most votes from the players such that the player whose caption receives the most votes is awarded one point.

2. The photo captioning game according to claim 1, further comprising:
said base housing having a front wall and a back wall and an outer wall extending between said front wall and said back wall;
said outer wall of said base housing having a bottom side and a first lateral side and a second lateral side;
said page back button being positioned on said front wall of said base housing;
said page back button being positioned between said base display and said bottom side of said outer wall of said base housing; and
said page back button being positioned closer to said first lateral side of said outer wall than said second lateral side of said outer wall.

3. The photo captioning game according to claim 2, further comprising:
said page back button having an exposed surface with respect to said front wall of said base housing;
said page back button having back arrow indicia being applied to said exposed surface; and
said back arrow indicia comprising an image of an arrow pointing toward said first lateral side of said outer wall of said base housing.

4. The photo captioning game according to claim 1, further comprising:
said base housing having a front wall and a back wall and an outer wall extending between said front wall and said back wall;
said outer wall of said base housing having a bottom side and a first lateral side and a second lateral side;
said page forward button being positioned between said base display and said bottom side of said outer wall of said base housing; and
said page forward button being positioned between said page back button and said second lateral side of said outer wall of said base housing.

5. The photo captioning game according to claim 4, further comprising:
said page forward button having an exposed surface of said page forward button with respect to said front wall of said base housing;
said page forward button having forward arrow indicia being applied to said exposed surface of said page forward button; and
said forward arrow indicia comprising an image of an arrow pointing toward said second lateral side of said outer wall of said base housing.

6. The photo captioning game according to claim 1, further comprising:
said base housing having a front wall and a back wall and an outer wall extending between said front wall and said back wall;
said outer wall of said base housing having a bottom side and a first lateral side and a second lateral side;
said shuffle button being positioned between said display and said bottom side of said outer wall of said base housing; and
said shuffle button being positioned closer to said page forward button than said second lateral side of said outer wall of said base housing.

7. The photo captioning game according to claim 1, further comprising:
said base housing having a front wall and a back wall and an outer wall extending between said front wall and said back wall;
said outer wall of said base housing having a bottom side and a first lateral side and a second lateral side;
a base power supply being integrated into said base housing, said base power supply being in electrical communication with said base processor, said base power supply comprising:
a rechargeable battery being integrated into said base housing, said rechargeable battery being in electrical communication with said base processor;
a power button being movably integrated into said front wall of said base housing, said power button being positioned between said display and said bottom side of said outer wall of said base housing, said power button being positioned between said page back button and said first lateral side of said outer wall of said base housing, said power button being in electrical communication with said base processor, said base processor being actuated when said power button is depressed an initial time, said base processor being de-actuated when said power button is depressed a subsequent time; and
a wireless charger being integrated into said back wall of said base housing, said wireless charger being in electrical communication with said rechargeable battery, said wireless charger being comprised of a ferromagnetic material.

8. The photo captioning game according to claim 7, further comprising:
a charging stand having a bottom end being configured to be positioned on a support surface;
said charging stand having a top end wherein said top end is configured to be elevated over the support surface;
said charging stand having a charge pad being coupled to said top end;
said charge pad lying on a plane being oriented perpendicular to an axis extending between said top end and said bottom end of said charging stand;
said charge pad being comprised of a magnetic material;
said charge pad magnetically engaging said wireless charger when said back wall of said base housing is positioned against said charge pad.

9. The photo captioning game according to claim 8, further comprising said charge pad broadcasting a charging signal to said wireless charger when said charge pad magnetically engages said wireless charger for charging said rechargeable battery.

10. The photo captioning game according to claim 8, further comprising:
said charging stand including a power cord being in electrical communication with said charge pad; and
said power cord having a male plug wherein said male plug is configured to be electrically mated to a power source comprising a female electrical outlet.

11. A photo captioning game comprising:
a base housing having a front wall and a back wall and an outer wall extending between said front wall and said back wall;
a base processor being integrated into said base housing;
a base display being coupled to said front wall of said base housing wherein said base display is configured to display imagery, said base display being in electrical communication with said base processor;
a base electronic memory being integrated into said base housing, said base electronic memory being in electrical communication with said base processor, said base electronic memory storing a database comprising a plurality of digital images and a vote counting application;
a base transceiver being integrated into said base housing, said base transceiver being in electrical communication with said base processor;
a page back button being movably integrated into said front wall of said base housing, said outer wall of said base housing having a bottom side and a first lateral side and a second lateral side, said page back button being positioned between said base display and said bottom side of said outer wall of said base housing, said page back button being positioned closer to said first lateral side of said outer wall than said second lateral side of said outer wall, said page back button being in electrical communication with said base processor, said base display being actuated to cycle back through said plurality of digital images stored in said database in said base electronic memory when said page back button is depressed, said page back button having an exposed surface with respect to said front wall of said base housing, said page back button having back arrow indicia being applied to said exposed surface, said back arrow indicia comprising an image of an arrow pointing toward said first lateral side of said outer wall of said base housing;
a page forward button being movably integrated into said front wall of said base housing, said page forward button being positioned between said base display and said bottom side of said outer wall of said base housing, said page forward button being positioned between said page back button and said second lateral side of said outer wall of said base housing, said page forward button being in electrical communication with said base processor, said base display being actuated to cycle forward through said plurality of digital images stored in said database in said base electronic memory when said page forward button is depressed, said page forward button having an exposed surface of said page forward button with respect to said front wall of said base housing, said page forward button having forward arrow indicia being applied to said exposed surface of said page forward button, said forward arrow indicia comprising an image of an arrow pointing toward said second lateral side of said outer wall of said base housing;
a shuffle button being movably integrated into said front wall of said base housing, said shuffle button being positioned between said display and said bottom side of said outer wall of said base housing, said shuffle button being positioned closer to said page forward button than said second lateral side of said outer wall of said base housing, said shuffle button being in electrical communication with said base processor, said base display being actuated to display a randomly selected one of said plurality of digital images stored in said database in said base electronic memory when said shuffle button is depressed;
a base power supply being integrated into said base housing, said base power supply being in electrical communication with said base processor, said base power supply comprising:
a rechargeable battery being integrated into said base housing, said rechargeable battery being in electrical communication with said base processor;
a power button being movably integrated into said front wall of said base housing, said power button being positioned between said display and said bottom side of said outer wall of said base housing, said power button being positioned between said page back button and said first lateral side of said outer wall of said base housing, said power button being in electrical communication with said base processor, said base processor being actuated when said power button is depressed an initial time, said base processor being de-actuated when said power button is depressed a subsequent time; and
a wireless charger being integrated into said back wall of said base housing, said wireless charger being in electrical communication with said rechargeable battery, said wireless charger being comprised of a ferromagnetic material;
a charging stand having a bottom end being configured to be positioned on a support surface, said charging stand having a top end wherein said top end is configured to be elevated over the support surface, said charging stand having a charge pad being coupled to said top end, said charge pad lying on a plane being oriented perpendicular to an axis extending between said top end and said bottom end of said charging stand, said charge pad being comprised of a magnetic material, said charge pad magnetically engaging said wireless charger when said back wall of said base housing is positioned against said charge pad, said charge pad broadcasting a charging signal to said wireless charger when said charge pad magnetically engages said wireless charger for charging said rechargeable battery, said charging stand including a power cord being in electrical communication with said charge pad, said power cord having a male plug wherein said male plug is configured to be electrically mated to a power source comprising a female electrical outlet;
a plurality of personal electronic devices, each personal electronic device of said plurality of personal electronic devices including a personal electronic memory, said personal electronic memory associated with each personal electronic device of said plurality of personal electronic devices storing a database comprising a photo captioning application, each personal electronic device of said plurality of personal electronic devices including a personal transceiver, said personal transceiver associated with each personal electronic device of said plurality of personal electronic devices being in wireless communication with said base transceiver, said plurality of personal electronic devices including a lead electronic device wherein said lead electronic device is configured to be assigned to a lead player, said plurality of personal electronic devices including a set of player electronic devices wherein each player electronic device of said set of player electronic devices is configured to be assigned to a respective one of a plurality of players, said photo captioning application stored in said personal electronic memory associated with each player electronic device of said set of player electronic devices generating a caption which pertains to said digital image which is displayed on said base display, said personal transceiver in each player electronic device of said set of player electronic devices broadcasting said caption generated by said photo captioning application stored in said personal electronic memory associated with each player electronic device of said set of player electronic devices to said base transceiver, said base display displaying said caption generated by said photo captioning application stored in said personal electronic memory associated with each player electronic device of said set of player electronic devices, said personal transceiver in each player electronic device of said set of player electronic devices broadcasting a vote to said base transceiver which pertains to said caption displayed on said base display wherein said personal transceiver in each player electronic device of said set of player electronic devices is configured to have each player of the plurality of players vote for their favorite caption, said vote counting application stored in said base electronic memory counting each vote which is broadcast to said base transceiver wherein said vote counting application is configured to determine which caption receives the most votes from the players such that the player whose caption receives the most votes is awarded one point.
